(19) United States
(12) Patent Application Publication
(10) Pub. No.: US 2008/0257729 A1
(43) Pub. Date: Oct. 23, 2008

(54) Galvanic corrosion monitoring and analyzing system

(76) Inventor: Farqad F.M. Saeed, Amman (JO)

Correspondence Address: ABELMAN, FRAYNE & SCHWAB, 666 THIRD AVENUE, 10TH FLOOR, NEW YORK, NY, 10017, US

(21) Appl. No.: 12/012,819

(22) Filed: Feb. 5, 2008

Related U.S. Application Data
(60) Provisional application No. 60/899,781, filed on Feb. 5, 2007.

(51) Int. Cl. G01N 27/26

(52) U.S. Cl. 204/404

(57) ABSTRACT

An electrochemical integrated system for measuring the galvanic current values and direction for two to four electrodes, comprising a corrosion cell and two to four electrodes coupled together via an interface and exposed to electrolyte for allowing electrochemical oxidation and reduction reactions to occur on the surface of the electrodes, characterized in that the two to four electrodes are flat metallic specimens made of different metals and alloys, and arranged adjacent and parallel to each other at the bottom of the corrosion cell so that the electrolyte is kept perpendicular on the flat specimens, with a non-corrosive material working as a barrier or isolator among them, wherein the whole combination of specimens is exposed to identical electrolytes under identical conditions allowing monitoring of the galvanic current values and directions at the same time for the whole combination.

### CROSS-REFERENCES TO RELATED APPLICATIONS

This application claims the benefit of U.S. Provisional Application No. 60/899,781, filed Feb. 5, 2007, the contents of which are incorporated by reference herein and made a part of this application.

### SUMMARY OF THE INVENTION

An electrochemical system (Software, Hardware and Galvanic Corrosion Cell) used to measure the galvanic current values and directions illustratively for two, three and/or four electrodes adjacent and parallel to each other with a non corrosive material working as a barrier or isolator among them (i.e., flat metallic specimens (15×30×2 mm) made of different metals and alloys), coupled together using the designed interface whereby the galvanic currents values and directions can be monitored at the same time for the whole combination by exposing it to identical corrosive medias (electrolytes) under identical conditions. The electrolyte is kept perpendicular on the flat specimens which are kept at the bottom of the corrosion cell to allow electrochemical reactions (Oxidations and Reduction) to occur on the surface of the coupled flat specimens which are connected via the interface through a special conducting channels designed in the corrosion cell and made of non-corrosive material to be connected through a special electrical wire with the designed interface, so that the researcher can use the control panel of the software package to measure galvanic currents (Values and directions in micro-amperes, milli-amperes and amperes), coupling potential using reference electrode, and all can be graphically mapped online with time at any time during the experiment without effecting the continuity of the electrochemical reaction due to the Galvanic Corrosion. In addition to the above, the given system enables the researcher to measure also the Temperature, pH, and to measure and control the speed of stirring motor (200-4000 RPM) for the electrolyte in the corrosion cell in order to control the migration of ions from the bulk of the electrolyte to the adjacent surface of the flat specimens when the electrochemical reaction is Mass Transfer Controlled. The corrosion cell has special openings to introduce inert gases such as Nitrogen or Argon to get rid of oxygen in order to conduct (Activation Controlled) electrochemical reactions. The system can be utilized for conducting researches on selecting materials for (Alloying, construction and Cathodic Protection by sacrificial anode purposes) and to study the localized (Pitting and Crevice) corrosion phenomena generated due to the galvanic coupling among metals. Also this system enable the researchers to predict new galvanic series of metals by introducing new corrosive environments rather than sea water which is obvious in most International Standards. This system enables the researcher to explore and identify thoroughly the causes of reversal of polarity which occur among metals at certain temperatures and area ratio of Cathode to Anode and cause disastrous situations due to the galvanic action.

### BRIEF DESCRIPTION OF THE DRAWINGS

FIG. 1 is a block diagram of a galvanic corrosion monitoring and analyzing system according to the present invention;

FIGS. 1A to 1C are graphical user interfaces of a control panel that displays the galvanic corrosion monitoring and analyzing system (GCMAS) of the present invention;

FIG. 2 is a display of a graphical support display panel of the GCMAS;

FIG. 3 is a display of a graphical support panel of the GCMAS used to get previously saved graphs;

FIG. 4 is a display of a graphical support panel of the GCMAS using cursors (shown in yellow colored lines) to get values of each point on each graph (shown in blue color);

FIG. 5 is a display of a data support panel of GCMAS used to store data (galvanic currents, coupling potential and summation of galvanic currents;

FIG. 6 is a display of a data support panel of GCMAS used to get previously stored data (galvanic currents, coupling potential and summation of galvanic currents);

FIG. 7 illustrates an interface card connected to data acquisition card of the present invention;

FIG. 8 depicts the front panel of the interface card of FIG. 7;

FIG. 9 depicts a galvanic corrosion cell of the present invention;

FIG. 10 is an exploded view of the galvanic corrosion cell of FIG. 9;

FIG. 11 is a Table listing the components of the galvanic corrosion cell of FIG. 9;

FIG. 12 depicts a reference electrode of the galvanic corrosion cell of FIG. 9; and

FIG. 13 depicts an inlet and outlet gas ports of the galvanic corrosion cell of FIG. 9.

To facilitate understanding of the invention, the same reference numerals have been used when appropriate, to designate the same or similar elements that are common to the figures. Further, unless stated otherwise, the drawings shown and discussed in the figures are not drawn to scale, but are shown for illustrative purposes only.

### DETAILED DESCRIPTION OF THE PREFERRED EMBODIMENTS

The present invention is a galvanic corrosion monitoring and analysis system (GCMAS) comprising a Software package, Hardware including an Interface Card and a Data Acquisition Card, and a Galvanic Corrosion Cell.

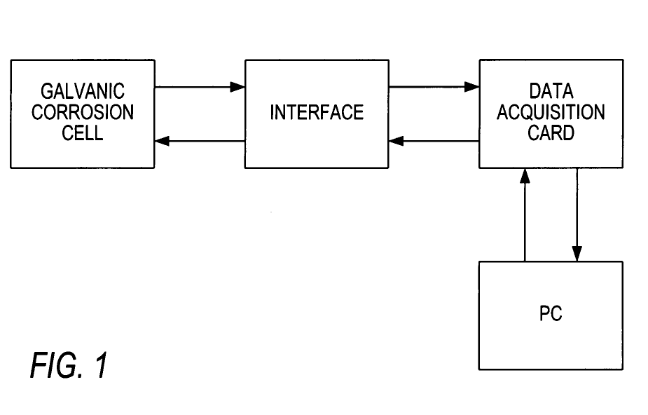

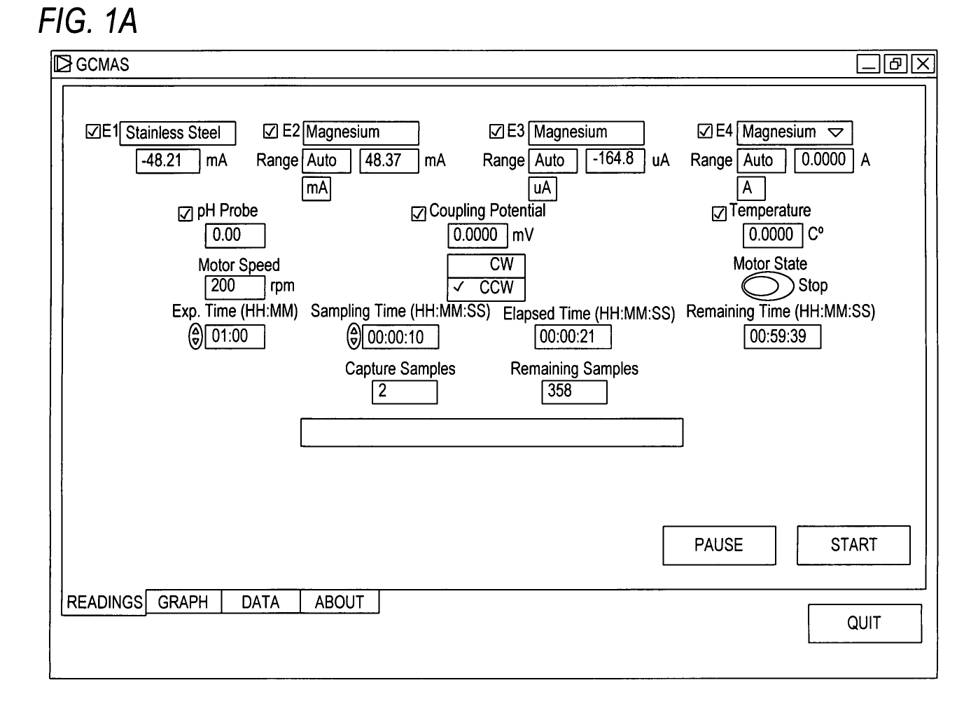

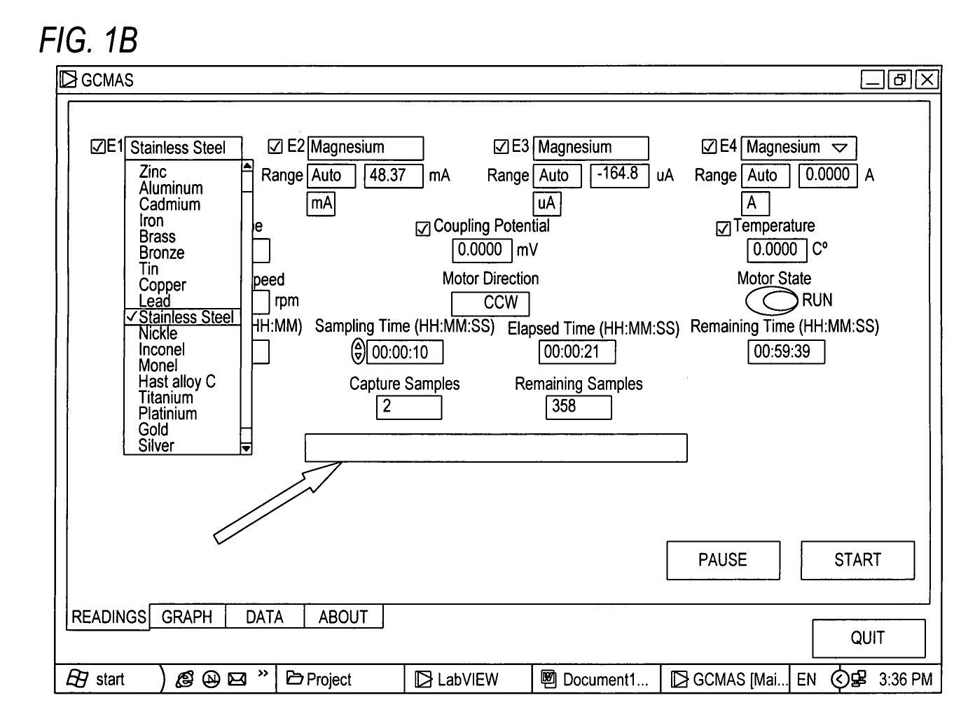

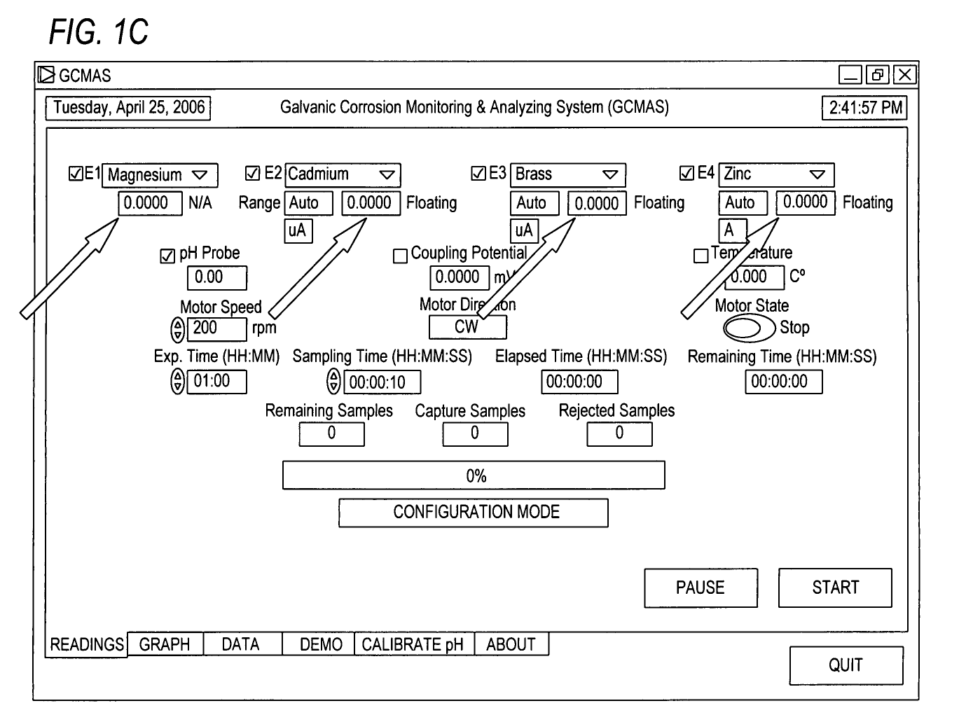

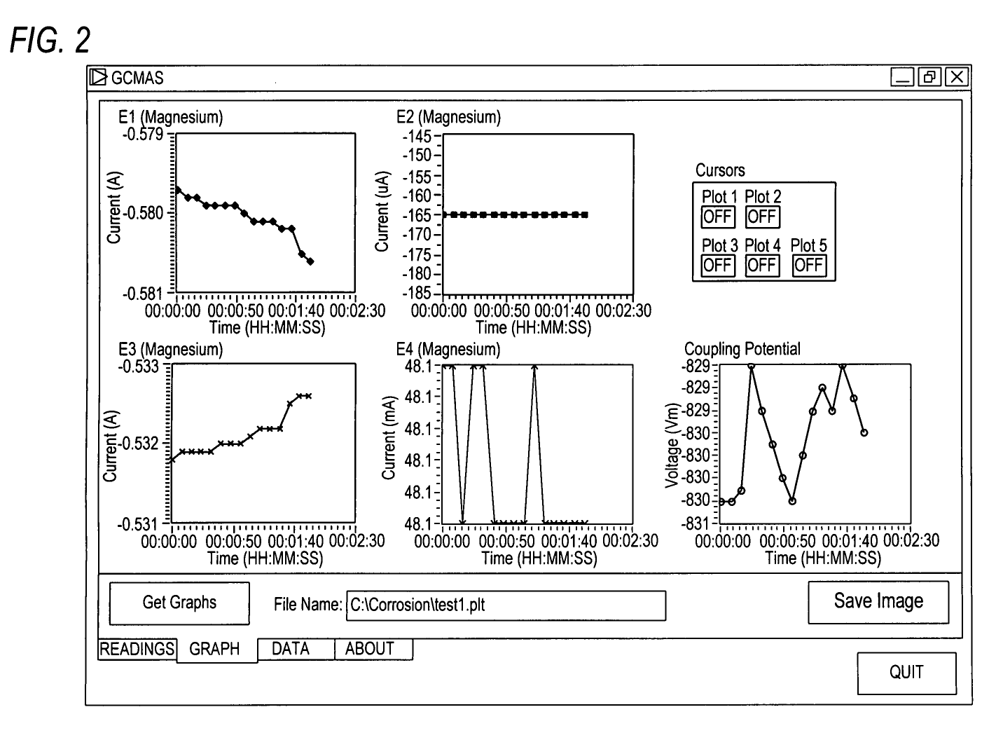

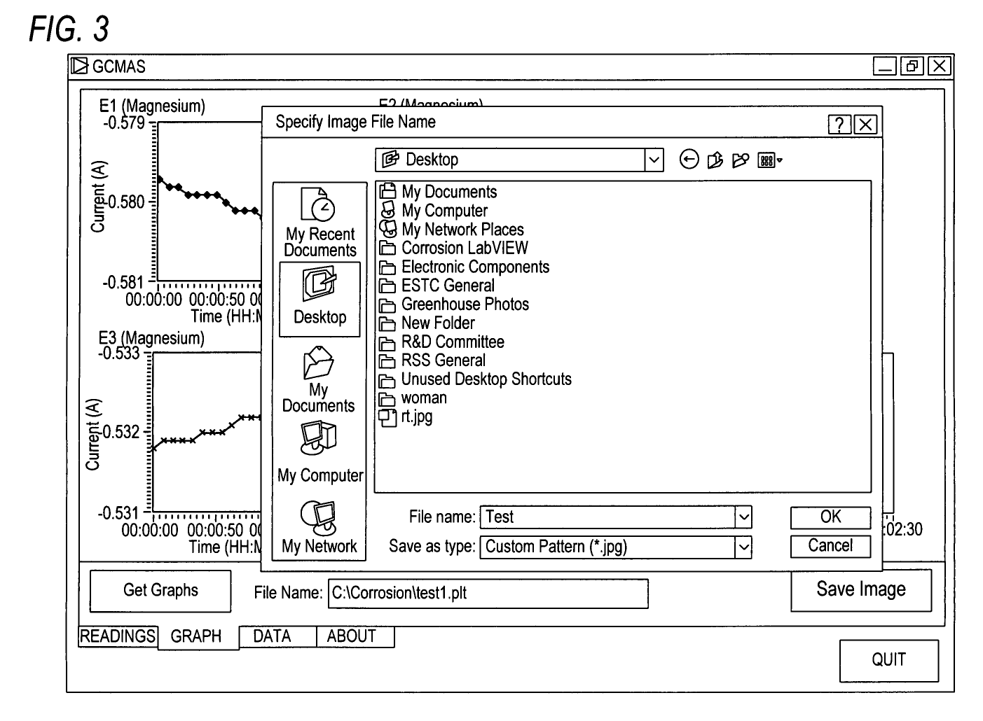

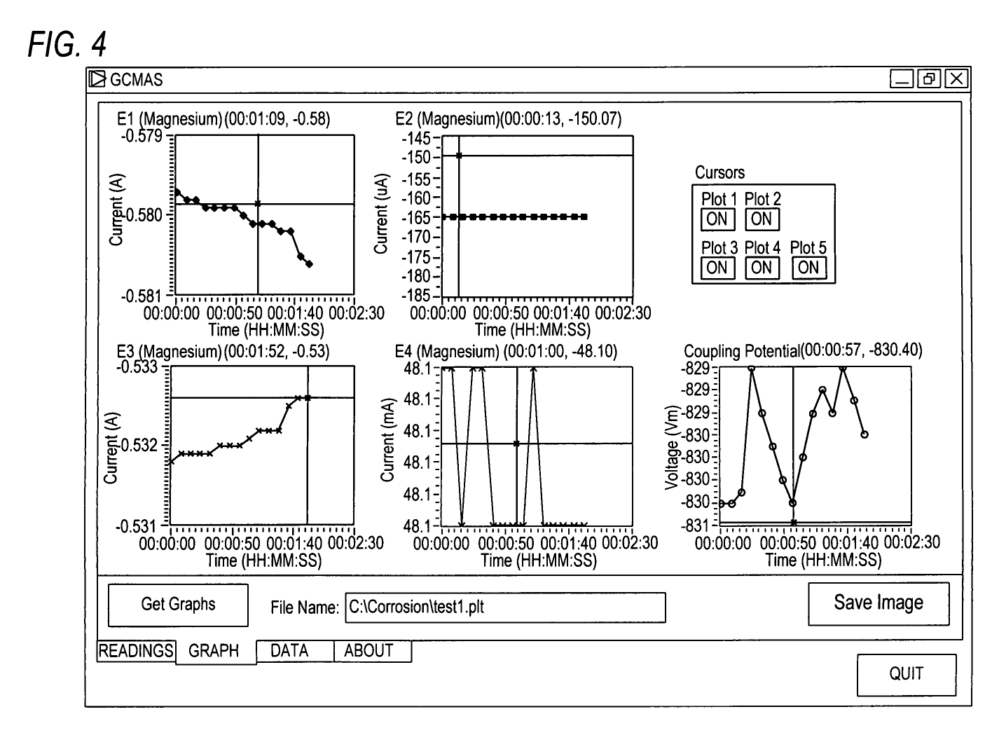

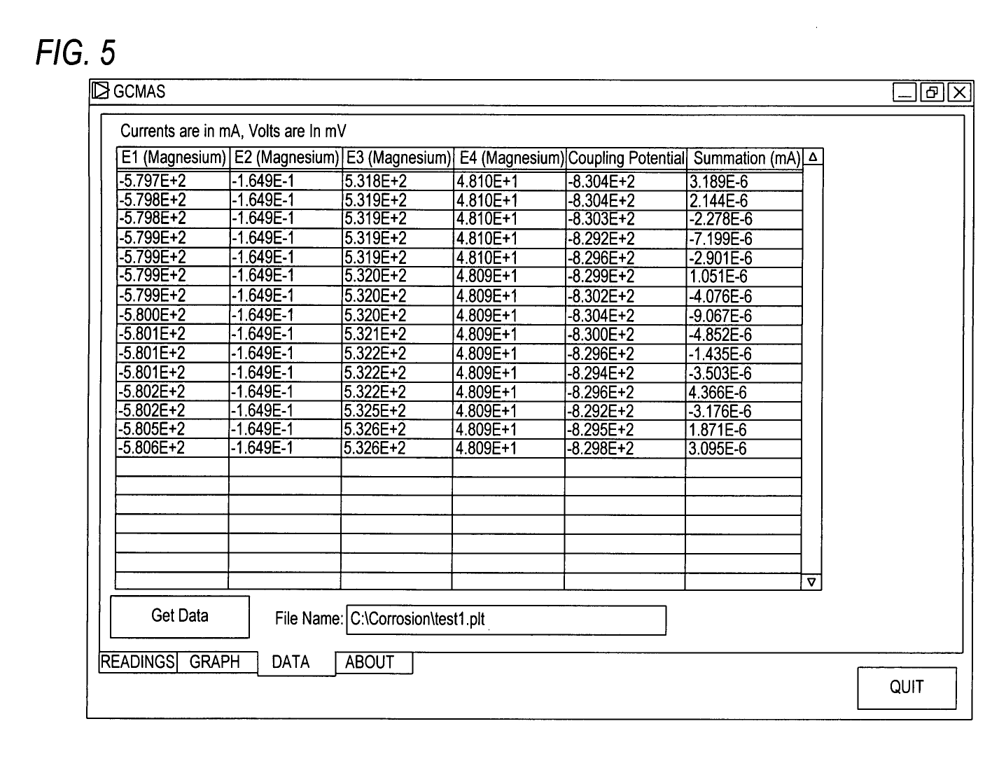

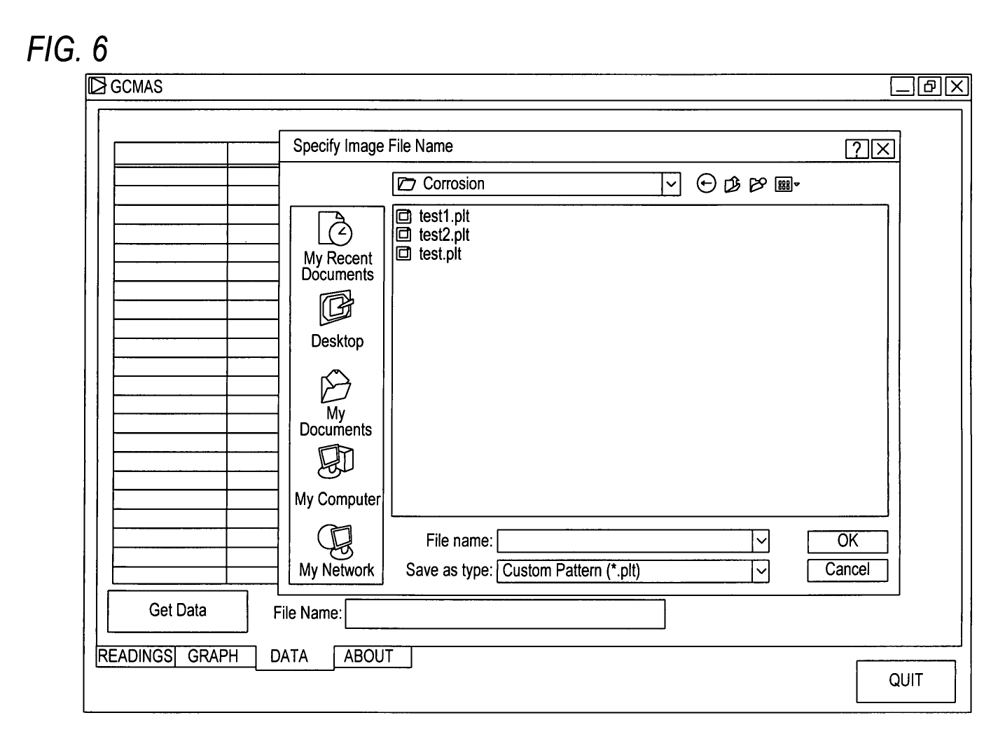

The present invention includes a software package shown in FIGS. 1-6 that was designed and fabricated using (AUTOLAB 6) and works under the environment of (Windows XP, Me and 2000), requires a Pentium 4 processor with processing speed of 2.8 Ghz and RAM of 256 Mb.

This software is used to conduct coupling through the Interface card and the galvanic corrosion cell among, for example, two, three and four electrodes at a time (i.e., flat metallic specimens (15×30×2 mm)) in order to study the galvanic corrosion problem in industry in addition to the cathodic protection by sacrificial anode. This software controls the whole Galvanic Corrosion experiment. It enables the user to select the name of each metallic electrode from the list given below each electrode as it is shown in FIGS. 1A-C, as well as the number of electrodes needed to be coupled and up to four electrodes at a time by pointing a green tick on each selected electrode. The user can choose the measurement of coupling potential, Temperature and pH. Also the motor can be operated by selecting the speed between 200-4000 RPM and the direction of motion (clock-wise and counter-clock-wise). Then the user can insert the time of the experiment in hours and minutes (HH:MM) and sampling time in hours, minutes and seconds (HH:MM:SS) according to the desire experiment.

Galvanic currents readings can appears in either micro amps, milliamps and amps, or selecting “Auto” to let the software choose the unit. The software has the ability to store data Galvanic currents, coupling potential and summation of currents and graphical mapping of Galvanic currents and coupling potential with time during the experiment, and without effecting the continuity of the electrochemical reaction due to the Galvanic Corrosion. In addition to the above, the software package enables the user to monitor the elapsed time, remaining time, captured samples and remaining samples of the experiment, as well as the percentage progress bar of the experiment and to pause or quit the experiment at any time. The designed software package enables the user to use a cursor to get the value of Galvanic Currents and coupling potential with time at any point on the graph and has the ability to regain previously stored data and saved graphs. The current magnitude and the direction can be monitored using the control panel as shown in FIGS. 1A to 1C. All above features are shown in FIGS. 1-6.

2. Hardware Consists the Following:

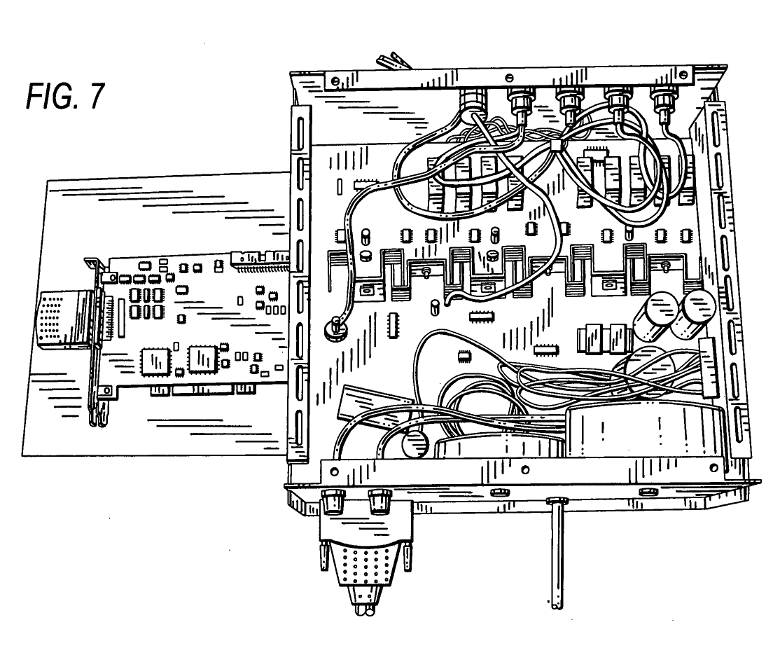

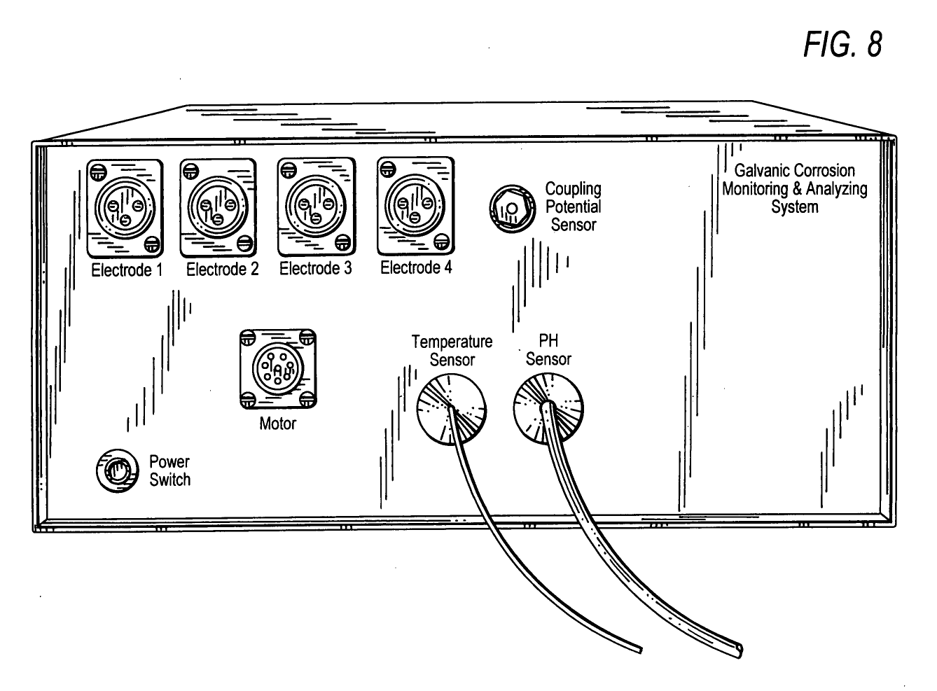

a. Interface Card as shown in FIGS. 7 and 8, was designed and fabricated to measure and control the features given in the designed software. The Interface card is placed between the corrosion cell and the Data Acquisition Card. The interface card is an analog to digital and digital to analog converter. Referring to FIG. 7, the Interface card is identified by the arrow.

b. Data Acquisition Card: (shown in FIG. 7) Collects Data from the interface card to the software stored in the computer device.

3. Galvanic Corrosion Cell:

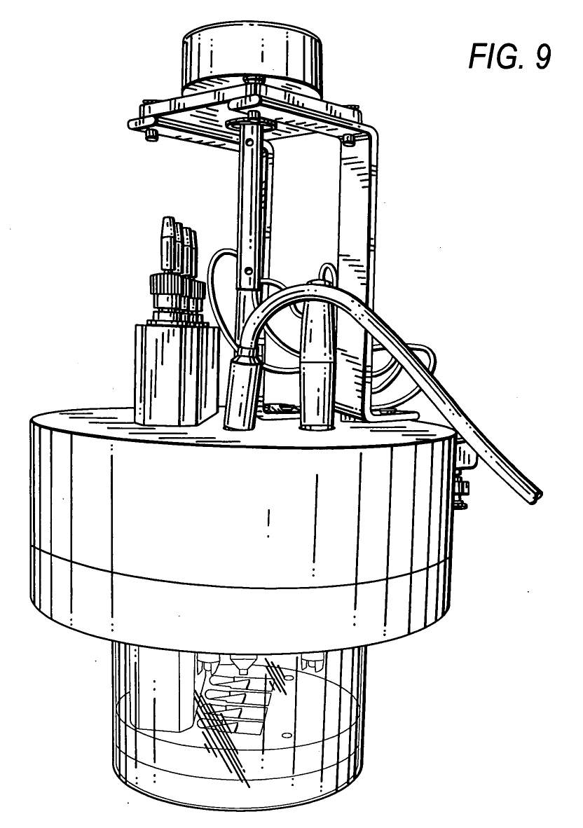

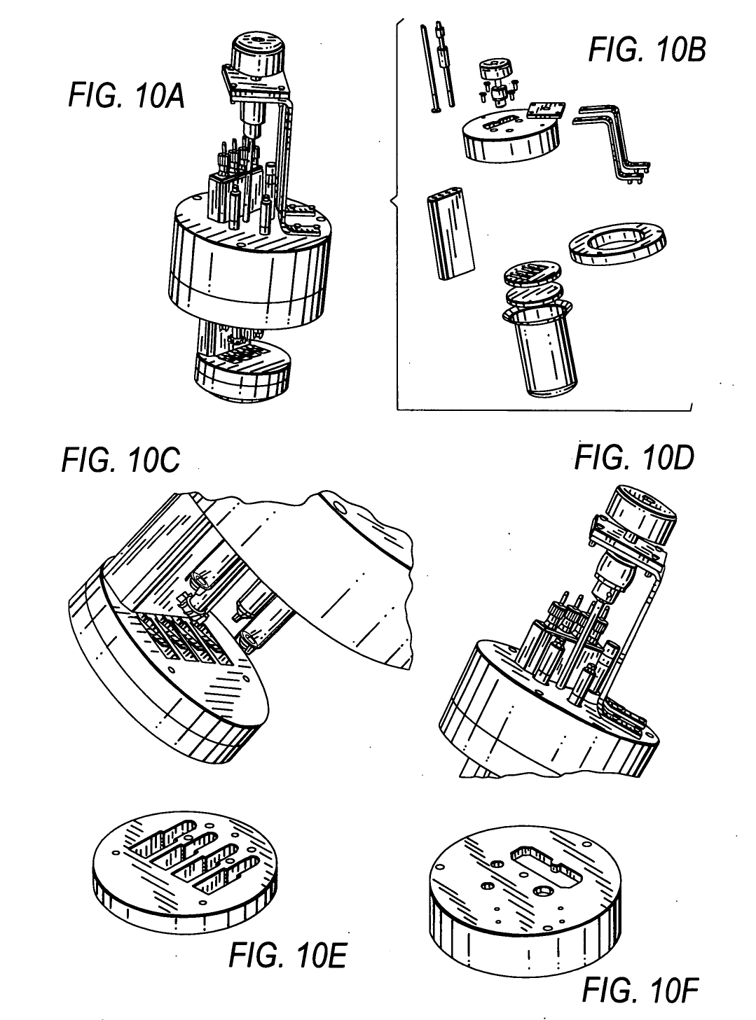

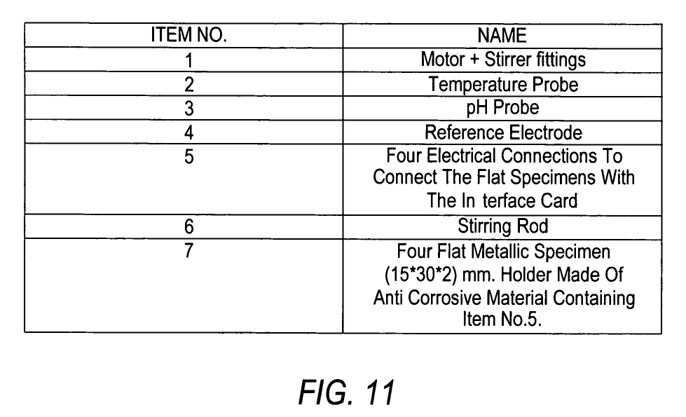

The Galvanic Corrosion Cell as set forth in FIGS. 9-11, is used to set (e.g., two, three and four) flat metallic specimens at a time of (15×30×2 mm) adjacent and parallel to each other with a non-corrosive material working as a barrier among them. The electrolyte is kept perpendicular on the flat specimens, which are kept at the bottom of the corrosion cell to allow electrochemical reactions oxidations and reduction to occur on the surface of the coupled flat specimens. The specimens (i.e., electrodes) are totally submerged in the electrolyte.

The reason of keeping the electrolyte perpendicular to the surface of the specimen is to advantageously benefit from the pressure head generated by the electrolyte according to the relation:

(Pressure head (P)(N/m²)=Density (ρ)×gravity (g)×Height of solution in the cell (h)).

The mixer plays an important role in increasing the aggressiveness of the electrochemical reaction by introducing dynamic behavior to the system which will be reflected positively on increasing the rate of movement of ions and increasing the reduction reaction on the metallic surface when the reaction is mass transfer controlled, i.e., Reduction of Oxygen ions in aerated acidic, neutral or alkaline solutions as follows:

O₂+4H⁺+4e→2H₂O

O₂+2H₂O+4e→4OH⁻

The imposed agitation forces by the mixer provide an important role by increasing the turbulence of the electrolyte and, as a result, increase the rate of reaching the oxygen ions to the surface of the flat metallic specimens, which will increase the oxidation reaction (dissolution rate of the flat metallic specimens).

Four conducting channels made of non-corrosive material and four electrical wires inserted inside these channels are used to connect the flat specimens to the interface. The Galvanic Corrosion Cell enables the user to connect (Reference Electrode, Temperature, pH) probes and stirring motor for the electrolyte and used also to introduce inert gases such as Nitrogen or Argon to get rid of oxygen in order to conduct (Activation Controlled) electrochemical reactions.

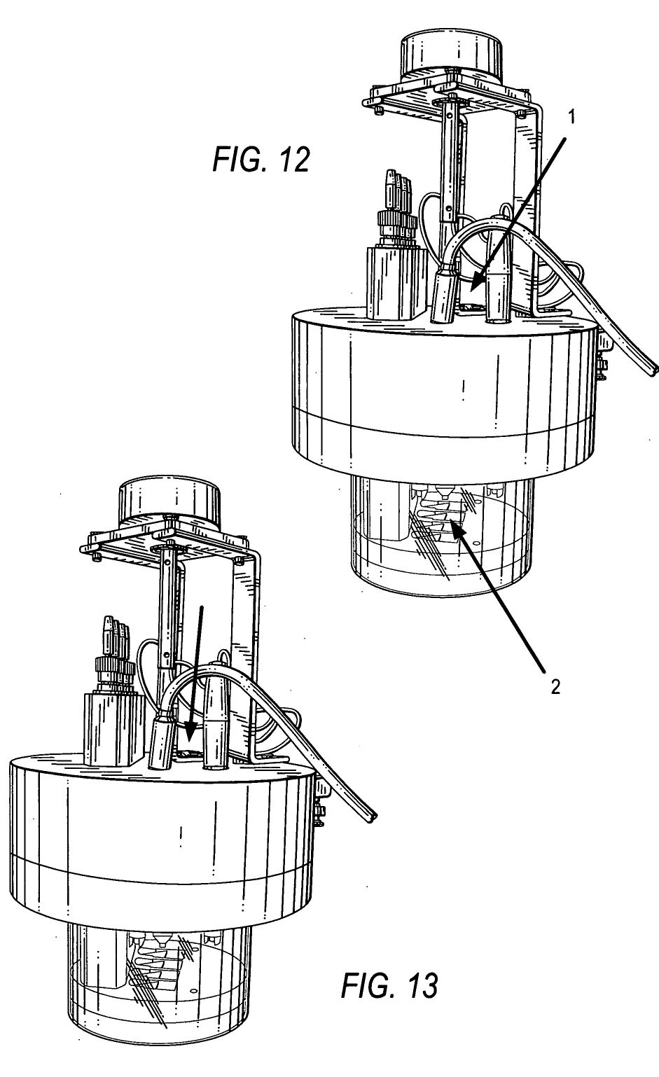

In one embodiment, the reference electrode is inserted through the opening of the cover into the corrosion cell (as shown in FIG. 12 (arrow 1)), so that the tip of the electrode will be submerged in the electrolyte (arrow 2) in order to measure the coupling potential of the electrodes through the ionic diaphragm of the reference electrode (i.e., calomel electrode, among other types of electrodes).

In one embodiment, the type of temperature probe is being used is a diaphragm temperature probe with temperature range between 0-100 C. The pH probe can be a diaphragm pH probe having a range of 0-14, and additional calibration must be conducted using buffer solutions before each test run.

The inlet ports to introduce the inert gases, such as Nitrogen and Argon, are located at the cover of the corrosion cell as shown in the red arrow. The outlet port to remove the oxygen is located also at the cover of the cell near the inlet port used to introduce the inert gases Nitrogen and Argon.

It will be apparent to those skilled in the art that various modifications and variations can be made to the present invention without departing from the spirit and scope of the invention. Thus, it is intended that the present invention cover the modifications and variations of this invention that come within the scope of the appended claims and their equivalents.

What is claimed is:

1. An electrochemical integrated system for measuring the galvanic current values and direction for two to four electrodes, comprising a corrosion cell and two to four electrodes coupled together via an interface and exposed to electrolyte for allowing electrochemical oxidation and reduction reactions to occur on the surface of the electrodes, characterized in that the two to four electrodes are flat metallic specimens (7) made of different metals and alloys, and arranged adjacent and parallel to each other at the bottom of the corrosion cell so that the electrolyte is kept perpendicular on the flat specimens (7), with a non-corrosive material working as a barrier or isolator among them, wherein the whole combination of specimens (7) is exposed to identical electrolytes under identical conditions allowing monitoring of the galvanic current values and directions at the same time for the whole combination.

2. The system of claim 1, wherein the flat metallic specimens (7) are connected to the interface through four conducting channels made of non-corrosive material and four electrical wires inserted inside these channels.

3. The system of claim 1, further comprising a reference electrode (4), a temperature probe (2), a pH probe (3), and a stirring motor for the electrolyte in order to control the migration of ions from the bulk of the electrolyte to the adjacent surface of the flat specimens (7) when the electrochemical reaction is mass transfer controlled.

4. The system of claim 1, further comprising inert gas such as nitrogen or argon to get rid of oxygen in order to conduct the electrochemical reactions in the corrosion cell.

5. The system of claim 1, further comprising a software package enabling the user to select the number of flat specimens to be coupled in order to measure the galvanic current values in microampere, milliampere and ampere as well as the directions, to choose measuring or not measuring the coupling potential using a reference electrode, and storing data during the experiment without effecting the continuity of the electrochemical reaction due to the galvanic corrosion, to choose measuring or not measuring the temperature and pH, and to measure and control the speed of a stirring motor and direction of stirring for the electrolyte in the corrosion cell in order to control the migration of ions from the bulk of the electrolyte to the adjacent surface of the flat specimens (7) when the electrochemical reaction is mass transfer controlled.
